(19) United States
(12) Patent Application Publication
(10) Pub. No.: US 2002/0195042 A1
(43) Pub. Date: Dec. 26, 2002

(54) Vehicle direction signal device

(76) Inventor: George Lamont Williams, San Antonio, TX (US)

Correspondence Address: GEORGE LAMONT WILLIAMS, 3200 THOUSAND OAKS #701, SAN ANTONIO, TX, 78247, US

(21) Appl. No.: 10/176,996

(22) Filed: Jun. 21, 2002

Related U.S. Application Data
(63) Continuation of application No. 60/299,872, filed on Jun. 21, 2001.

(51) Int. Cl. B60Q 1/34

(52) U.S. Cl. 116/35 R; 116/42

(57) ABSTRACT

Vehicle Direction Signal Device with a housing, a light bulb holder fixedly attached within the housing, a standard light bulb removably attached to the light bulb holder and a green tinted transparent front lens attached to the front of the housing. The signaling device or devices simultaniously emit a flashing green color when the vehicle driver actuates the signaling device from within the vehicle. The signaling device is built into or attached to the front facing portion of the vehicle. The signaling device powered by the electrical system of the vehicle. The signaling device is capable of telling other drivers at a four way intersection that the signaling vehicle is about to continue in a straight direction.

### CROSS REFERENCE TO RELATED APPLICATIONS

This is a continuation of Provisional Patent Serial No. 60/299,872, filed on Jun. 21, 2001.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of signaling devices and more specifically to vehicle direction signal device.

Since the earliest days of the development of the automobile and other motorized vehicles, various indicator lights have been added to the outside surface of the vehicle that can be activated by the driver to warn other drivers of his or her intentions. These include brake lights, turn signals and hazard warning flashes.

These indicators are illuminated devices that are powered by the vehicles electrical system. Generally the brake lights are red in color and the turn signals and hazard are amber.

There is however, a driving condition that can cause confusion to other drivers and that does not currently have an indicator to give notice of the condition. That is when a driver arrives at a four way intersection along with one or more drivers that approach the same intersection. The drivers need to signal there intension to each other. A conscientious driver will use his or her turn signal to indicate a turn, however, a less conscientious driver may neglect to do so. In the spirit of driving defensively, it would be advantageous for a driver to have an additional indicator that would signal to other drivers that the driver intends to proceed in a straight ahead direction.

### BRIEF SUMMARY OF THE INVENTION

The primary object of the invention is to provide a vehicle signal device that lets nearby motorists know that the vehicle is about to continue in a straight ahead direction.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Vehide Direction Signal Device comprising: a housing, a light bulb holder fixedly attached within said housing, a standard light bulb removably attached to said light bulb holder, a green tinted transparent front lens attached to the front of said housing, said signaling device or devices simultaniously emitting a flashing green color when the vehicle driver actuates said signaling device from within said vehicle, said signaling device built into or attached to the front facing portion of said vehicle, said signaling device powered by the electrical system of said vehicle, and said signaling device capable of telling other drivers at a four way intersection that said signaling vehicle is about to continue in a straight direction.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention

FIG. 1 is a front view of a vehicle showing the present invention built into or affixed to the rear view mirror or mirrors of a vehicle of mounted of the vehicle.

FIG. 2 is a front view of a vehicle showing the present invention mounted within the front headlights of the vehicle.

FIG. 3 is a front view of a vehicle showing the present invention mounted next to the turn signal indicators and other locations on the front surface of the vehicle.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

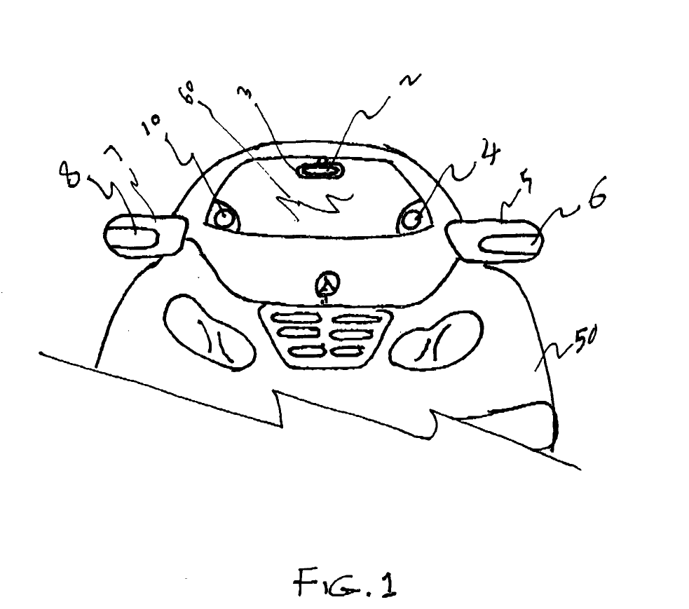

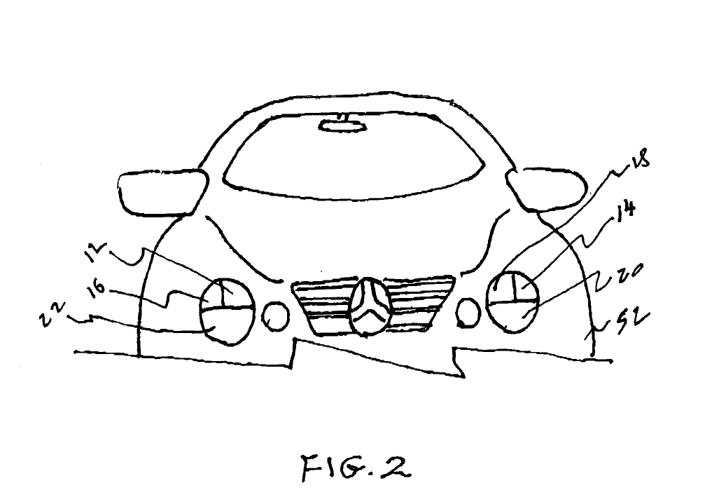

Referring now to FIG. 1 we see a front view of a vehicle 50 showing various locations for the straight ahead indicator of the present invention. The indicator 2 can be built into or affixed to the front facing surface of the internal rear view mirror 3. Alternately the indicators 6, 8 can be built into the front facing surface of the external rear view mirrors 5, 7. Another possible location is shown at the lower corners 4, 10 of the front wind shield 60 Indicators 4, 10 can be added to the vehicle by the vehicle owner as an after market product, or can be built into the vehicle by the manufacturer. The straight ahead indicator is activated by the driver by a switch that may be added to the turn indicator stem or other convenient location. In all cases, the straight ahead indicators have a green tinted front lens and simultaneously flash for a preset period of time such as ten seconds. The green color would be the universal sign for straight ahead. In all cases the straight ahead indicator is comprised of a housing, a light bulb holder and removable, replaceable light bulb within the housing and a front green tinted lens attached to the front of the housing. The straight ahead indicator of the present invention is constructed in the commonly accepted way that current turn indicators are made and is powered by the vehicle's electrical power system. An alternate embodiment of the present invention includes using a plurality of high Intensitygreeen colored LED's in place of a standard light bulb. The electrical design of the indicators in all possible locations is such that both straight and turn indicators can not be activated simultaneously. FIG. 2 shows a vehicle 52 having an additional possible location for the straight ahead signaling device of the present invention where the device is built into the front headlight quadrant 12, 18. The main headlights 20, 22 and turn signals 16, 20 are placed in their normal position.

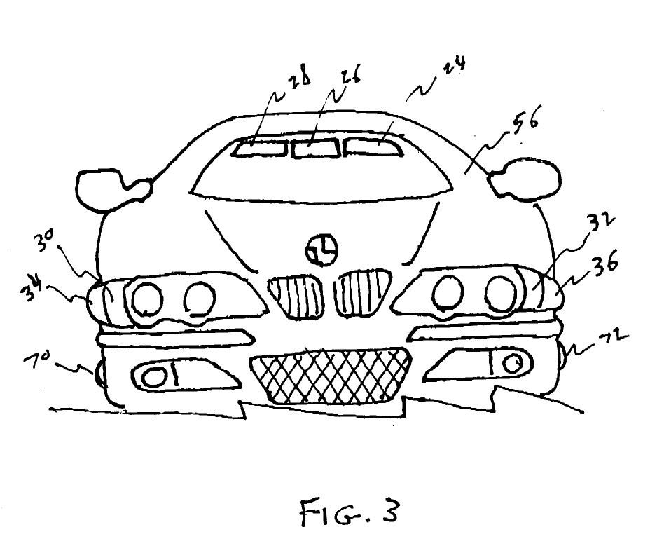

FIG. 3 shows a vehicle 56 having additional locations for the indicator of the present invention. Straight indicators 30, 32 are mounted adjacent to turn indicators 34, 36. Alternately, the straight ahead indicators can be installed at the top front of the front windshield 24, 26, 28. Another possible location is to include the straight ahead indicator in the front turn signal lights 70, 72 located at the side, front portion of the vehicle. In all cases, the straight ahead indicators of the present invention flash simultaniously. In all cases the front indicators would flash on and off as is common with existing turn indicator devices. Obviously, there are other possible locations on the front facing surface of a vehicle that may be acceptable for placing the straight ahead signal indicator of the present location.

As the above description and illustrations show, the straight ahead signal indicator of the present invention can be placed in a variety of locations and can help drivers communicate with each other at an intersection to help tell other drivers that it is the intention of the vehicle to proceed in a straight.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Vehicle Direction Signal Device comprising:
a housing, a light bulb holder fixedly attached within said housing, a standard light bulb removably attached to said light bulb holder, a green tinted transparent front lens attached to the front of said housing;
said signaling device or devices simultaniously emitting a flashing green color when the vehicle driver actuates said signaling device from within said vehicle;
said signaling device built into or affixed to the front facing portion of said vehicle;
said signaling device powered by the electrical system of said vehicle;
said signaling device automatically remaining on for a fixed period of time such as ten seconds and then automatically turning off; and
said signaling device capable of telling other drivers at a four way intersection that said signaling vehicle is about to continue in a straight direction.

2. Vehicle Direction Signal Device as claimed in claim 1 wherein said device is mounted next to the turn signal of said vehicle.

3. Vehicle Direction Signal Device as claimed in claim 1 wherein said device is mounted within said vehicle on the left and right side of the front windshield.

4. Vehicle Direction Signal Device as claimed in claim 1 wherein said device is mounted in an integral fashion within the front headlights of said vehicle.

5. Vehicle Direction Signal Device as claimed in claim 1 wherein said device is mounted within the rear, forward facing portion of the external rear view mirrors of said vehicle.

6. Vehicle Direction Signal Device as claimed in claim 1 wherein said device can not be operated simultaneously with the turn signals of said vehicle.

7. Vehicle Direction Signal Device as claimed in claim 1 wherein said device is affixed to or built into the front facing portion of the internal rear view mirror of said vehicle.

8. An alternate embodiment of said signal device as claimed in claim 1 wherein a plurality of green colored LED's are used as a light source in place of said standard light bulb.
